(19) United States
(12) Patent Application Publication
(10) Pub. No.: US 2004/0166981 A1
(43) Pub. Date: Aug. 26, 2004

(54) High torque continuous variable transmission

(76) Inventors: Paul D. Copioli, Sterling Heights, MI (US); James R. Yaxley, Macomb, MI (US); Robert Korson, Oak Park, MI (US); William D. Baedke, Romeo, MI (US); Christopher L. Jones, Sterling Heights, MI (US); Ryan E. Caldwell, Sterling Heights, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/783,487

(22) Filed: Feb. 20, 2004

Related U.S. Application Data
(60) Provisional application No. 60/448,770, filed on Feb. 20, 2003.

(51) Int. Cl. F16H 3/72; F16H 37/06; F16H 37/02

(52) U.S. Cl. 475/5

(57) ABSTRACT

A variable speed maximal torque transmission includes a planetary gear set made up of a peripheral ring gear enmeshing multiple planet gears. A sun gear simultaneously engages the planet gears. A carrier operative as a transmission output is in mechanical communication with the planetary gear set. The carrier is operative to power a drive wheel of a vehicle. A main motor is in mechanical drive communication with the sun gear and an auxiliary motor drives the peripheral ring gear.

### RELATED APPLICATION

This application claims priority of U.S. Provisional Patent Application Serial No. 60/448,770 filed Feb. 20, 2003, the contents of which are incorporated herein by reference.

### FIELD OF THE INVENTION

The present invention generally relates to a power transmission system and more particularly to a continuously variable transmission including a ring gear motor in order to control the speed of a ring gear portion of a planetary gear transmission assembly.

### BACKGROUND OF THE INVENTION

Continuously variable drive systems are well known in the art to provide a transmission which allows for a wide range of speeds to be achieved over a continuous range. An attractive feature of a continuously variable speed ratio is the improvement of efficiency of a drive motor and therefore improved overall efficiency. Continuously variable transmissions also find application in a variety of other fields in order to provide continuous speed variation over a given range.

While most motor vehicles having continuously variable transmission systems transmit power from the vehicle drive to the wheels by way of a variable ratio transmission that must withstand high torque and other conditions encountered, there are a host of other applications where maximal torque is required. Some instances where maximal torque output is required illustratively include steep grade movement, low friction contact surfaces, heavy load pulling and the like. Many commercial vehicles, especially those involved in earth moving and mining, experience such operating conditions. Prior art attempts to deliver maximal output torque in a continuously variable transmission have met with limited success owing to problems such as rapid component fatigue and failure, insufficient power density, limitations on variable speed range, and incomplete understanding of the physical processes taking place within the transmission. Thus, there exists a need for a continuously variable transmission able to obtain several speed ratios while maintaining a maximal output torque.

### SUMMARY OF THE INVENTION

A variable speed maximal torque transmission includes a planetary gear set made up of a peripheral ring gear enmeshing multiple planet gears. A sun gear simultaneously engages the planet gears. A carrier operative as a transmission output is in mechanical communication with the planetary gear set. The carrier is operative to power a drive wheel of a vehicle. A main motor is in mechanical drive communication with the sun gear and an auxiliary motor drives the peripheral ring gear.

A process for operating a transmission at continuous variable speeds while delivering maximal torque involves turning the planetary gear set through power inputs from the main motor and the auxiliary motor. The carrier is driven at maximal torque across variable speeds as a result.

### BRIEF DESCRIPTION OF THE DRAWINGS

FIG. 1 is a schematic cross-sectional view of a planetary gear arrangement operative in the present invention;

FIG. 2 is a schematic view illustrating gear motions according to the planetary gear arrangement of FIG. 1;

FIG. 3 is a planar view of an inventive transmission;

FIG. 4 is a side view of the transmission according to FIG. 3;

FIG. 5 is a top view of an inventive transmission according to FIG. 3; and

FIG. 6 is a perspective view of an inventive transmission according to FIG. 3.

### DETAILED DESCRIPTION OF THE PREFERRED EMBODIMENTS

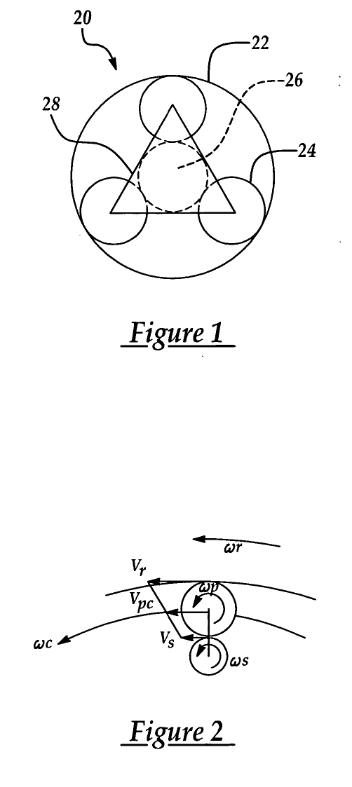

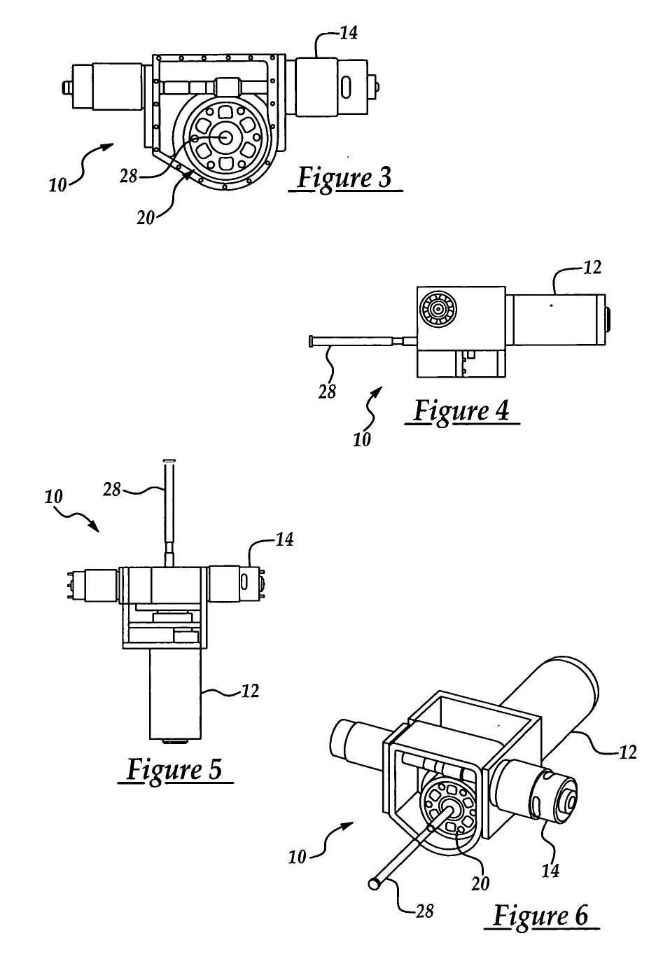

With reference to the figures, an inventive variable speed maximal torque transmission is shown generally at 10. A drive motor 12 is maintained at a constant design speed by an auxiliary motor 14. The auxiliary motor 14 turns a planetary gear set shown generally in FIG. 1 at 20 through mechanical engagement of a ring gear 22. Through control of ring gear rotation speed, the present invention allows for one to attain multiple speed ratios while delivering maximal torque. The planetary gear set 20 has an encompassing ring gear 22 enmeshed with a set of planet gears shown in FIG. 1 at 24. The planet gears 24 also engage a sun gear 26 concentric with the ring gear 22. A carrier 28 is also in mechanical engagement with the planetary gear set 20.

An inventive transmission is constructed about this arrangement for a particular application based on the following equations for determining the motion of a rotating ring gear within an inventive planetary gear set. Necessary operating parameters are determined based upon the following equations assuming that input power to the planetary gear set of FIG. 1 is by way of sun gear 26. The carrier 28 represents an output from the inventive transmission operative for instance to power a drive wheel of a vehicle. It is appreciated that one may readily depart from these assumptions and still derive an operative inventive transmission with modifications to the following equations. Based on the above assumptions with respect to input/output and ring gear 22 operating at constant speed, determination of carrier speed, carrier torque and ring gear reaction torque are readily obtained through the simultaneous solution of equations illustratively including kinematics of the planetary gear set 20, steady state equilibrium and well established principles of conservation of energy.

The following symbols are used with respect to FIG. 2 and result in the following solutions.

ωs=Sun gear angular speed

ωr=Ring gear angular speed

ωc=Carrier angular speed

Nr=Ring gear tooth number

Ns=Sun gear tooth number

SR=Speed ratio

Rr=Ring gear radius

Rs=Sun gear radius

Rp=Planet gear radius

Ts=Sun gear (input) Torque

Tr=Ring Gear Torque

Tc=Carrier (output) torque

Vs=Linear Velocity at sun gear pitch line

Vr=Linear Velocity at ring gear pitch line

Vpc=Linear velocity at planet gear spin axis

From geometry: Rr=Rs+2Rp

Rearranging the above:

$$Rp = \frac{Rr - Rs}{2}$$

From FIG. 2:

$$Vpc = \frac{ω s \cdot Rs + ω r \cdot Rr}{2} \\ Vpc = ( Rs + rp ) \cdot ω c \\ ( Rs + Rp ) \cdot ω c = \frac{ω s \cdot Rs + ω r \cdot Rr}{2} \\ \frac{1}{2} \cdot ( Rs + Rr ) \cdot ω c = \frac{1}{2} \cdot ω s \cdot Rs + \frac{1}{2} \cdot ω r \cdot Rr \\ ω c = \frac{( ω s \cdot Rs + ω r \cdot Rr )}{( Rs + Rr )} \qquad ( Eqn . 1 )$$

Determine Speed Ratio—SR (ωs/ωc):

$$W = \frac{ω r}{ω s}$$

$$\frac{1}{SR} = \frac{( Rs + W \cdot Rr )}{( Rs + Rr )}$$

$$SR = \frac{( Rs + Rr )}{( Rs + W \cdot Rr )}$$

Since gears are involved, gear tooth number

$$SRatio = \frac{( Ns + Nr )}{( Ns + W \cdot Nr )}$$

When ωr is 0:

$$SRatio = 1 + \frac{Nr}{Ns}$$

Steady-State Equilibrium: Tr+Ts+Tc=0

This assumes constant velocity

Tr=−(Tc+Ts) (Eqn. 2)

Conservation of Energy (Power)

Ts·ωs+Tc·ωc+Tr·ωr=0 (Eqn. 3)

Substitute (Eqn. 2) for Tr:

Ts·ωs+Tc·ωc+(−Tc−Ts)·ωr=0

Substitute (Eqn. 1) for ωc:

$$Ts \cdot ω s + Tc \cdot \frac{( ω s \cdot Rs + ω r \cdot Rr )}{( Rs + Rr )} + ( - Tc - Ts ) \cdot ω r = 0$$

Simplify and Solve for Tc (Output Torque):

$$Tc = - Ts \cdot \frac{( Rs + Rr )}{Rs}$$

This shows that output torque is constant and based on gear sizes only

$$SR = \frac{( Ns + Nr )}{( Ns + W \cdot Nr )}$$

This shows that the output speed can be different with a constant sun gear speed.

Torque Ratio is defined as Tout/Tsun (Tc/Ts):

$$TRatio = \frac{Tc}{Ts} = \frac{- ( Rs + Rr )}{Rs} = - ( 1 + \frac{Nr}{Ns} )$$

The negative sign just shows direction of torque vector.

Note that when (or is 0, then SRatio and TRatio are the same.

Since SR is positive, then the output rotates in the same direction as the sun gear.

It is appreciated that the auxiliary ring gear motor must be sized to handle the reaction torque.

Tr=−(Tc+Ts)

$$Tr = - [ - ( 1 + \frac{Nr}{Ns} ) \cdot Ts + Ts ]$$

$$Tr \geq Ts \cdot \frac{Nr}{Ns}$$

The above detailed operational equations of the inventive transmission did not use gear train efficiencies. It is appreciated that the efficiency of a conventional gear train is known and the available output torque and ring gear torque are reduced accordingly by the gear train efficiency. Comprehensive testing was performed to validate the above operational equations to within 10% accuracy on output torque and 5% accuracy on speed.

The foregoing description is illustrative of particular embodiments of the invention, but is not meant to be a limitation upon the practice thereof. The following claims, including all equivalents thereof, are intended to define the scope of the invention.

1. A variable speed maximal torque transmission comprising:
a planetary gear set comprising a peripheral ring gear enmeshing a plurality of planet gears and a sun gear in mechanical communication with said plurality of planet gears;
a carrier in mechanical communication with said planetary gear set;
a motor in mechanical drive communication with said sun gear; and
an auxiliary motor driving said peripheral ring gear.

2. The transmission of claim 1 wherein said carrier enmeshes said plurality of planet gears.

3. The transmission of claim 1 wherein said ring gear rotates at constant speed.

4. The transmission of claim 1 wherein said plurality of planet gears is three planet gears.

5. The transmission of claim 1 wherein said carrier is an output from the transmission.

6. The transmission of claim 1 wherein said carrier is coupled to a drive wheel of a vehicle.

7. The transmission of claim 1 wherein said auxiliary motor imparts power to said peripheral ring gear to satisfy the relationship
$$Tr \geq Ts \cdot \frac{Nr}{Ns}$$
where Tr is ring gear torque, Ts is sun gear torque, Nr is ring gear tooth number and Ns is sun gear tooth number.

8. A process for operating a transmission comprising:
turning a planetary gear set with an auxiliary motor through a mechanical engagement of a toothed ring gear encompassing a set of planet gears where said set of planet gears simultaneously engages a toothed sun gear; and
driving a carrier mechanically engaging said planetary gear set.

9. The process of claim 8 wherein said planetary gear set is turned at a variable speed.

10. The process of claim 8 wherein said carrier is a transmission output operative to power a drive wheel of a vehicle.

11. The process of claim 8 wherein turning said planetary gear set induces a torque on said carrier by way of a torque on said sun gear that satisfies the equation
$$TRatio = \frac{Tc}{Ts} = \frac{- ( Rs + Rr )}{Rs} = - ( 1 + \frac{Nr}{Ns} )$$
where Tc is the carrier torque, Ts is the sun gear torque, Nr is the tooth number of said ring gear, and Ns is the tooth number of said sun gear.
